(19) United States
(12) Patent Application Publication
(10) Pub. No.: US 2017/0094353 A1
(43) Pub. Date: Mar. 30, 2017

(54) SYSTEM AND METHOD FOR SHARING BLUETOOTH HARDWARE

(71) Applicants: Hisense Electric Co., Ltd., Qingdao (CN); HISENSE USA CORP., Suwanee, GA (US); Hisense International Co., Ltd., Qingdao (CN)

(72) Inventors: Lili CHANG, Laoshan District (CN); Jin CHENG, Laoshan District (CN)

(21) Appl. No.: 15/141,106

(22) Filed: Apr. 28, 2016

(30) Foreign Application Priority Data
Sep. 29, 2015 (CN) 201510633796.9

(51) Int. Cl. H04N 21/45; H04N 21/81; H04N 21/443; H04W 4/00; H04N 21/4363

(52) U.S. Cl. CPC H04N 21/4516; H04W 4/008; H04N 21/43637; H04N 21/443; H04N 21/818

(57) ABSTRACT

An embodiment of the present disclosure discloses a system and method for sharing Bluetooth hardware. The system comprises a first device, a second device, Bluetooth hardware, and a Bluetooth proxy module; both the first device and the second device are connected to the Bluetooth hardware, and the first device and the second device do not enable said Bluetooth hardware at the same time; both the first device and the second device are connected to the Bluetooth proxy module; the Bluetooth proxy module is configured to send indication information of disabling the Bluetooth hardware to the first device, and send connection configuration information to the second device, wherein the connection configuration information is a parameter used when the first device is connected to a Bluetooth peripheral via the Bluetooth hardware.

### CROSS-REFERENCE OF RELATED APPLICATION

The present application claims benefits and priority of Chinese patent application No. 201510633796.9 filed on Sep. 29, 2015, titled “SYSTEM AND METHOD FOR SHARING BLUETOOTH HARDWARE”, the entirety of which is incorporated herein by reference.

### FIELD OF TECHNOLOGY

The present disclosure relates to the field of electronic devices, and in particular to a system and method for sharing Bluetooth hardware.

### BACKGROUND

A TV set is part of modern life. Usually, with given hardware, the extended functions that can be achieved by TV sets are very limited. However, upgrading hardware of a TV set often means replacement of the TV set. That is, it is costly to upgrade hardware in the prior art. In order to realize hardware upgrading required by the extended functions without replacing the TV sets, there is a TV set in which TV set display and function extension hardware are separated, called hardware upgradable TV set.

In a hardware upgradable TV set, there are various combinations of TV set display and function extension hardware. One of the combinations is that the TV set and the function extension hardware for providing extended functions may have a respective operating system and may share Bluetooth hardware of the TV set. During the switchover of two operating systems, a connection related to Bluetooth hardware is to be switched between the function extension hardware and the TV set.

### SUMMARY OF THE DISCLOSURE

In a first aspect, an embodiment of the present disclosure provides a system for sharing Bluetooth hardware, including a first device, a second device, Bluetooth hardware, and a Bluetooth proxy module;

both said first device and said second device are connected to said Bluetooth hardware, and said first device and said second device do not enable said Bluetooth hardware at the same time; both said first device and said second device are connected to said Bluetooth proxy module;

said Bluetooth proxy module is configured to send indication information of disabling said Bluetooth hardware to said first device, and send connection configuration information to said second device, wherein said connection configuration information is a parameter used when said first device is connected to a Bluetooth peripheral via said Bluetooth hardware;

said first device is configured to receive the indication information of disabling said Bluetooth hardware, and disable said Bluetooth hardware according to the indication information of disabling said Bluetooth hardware; and

said second device is configured to receive said connect configuration information, and after enabling said Bluetooth hardware, connect to said Bluetooth peripheral via said Bluetooth hardware by using said connection configuration information.

In a second aspect, an embodiment of the present disclosure provides a method for sharing Bluetooth hardware, applied to the system for sharing Bluetooth hardware provided in the first aspect, including:

by a Bluetooth proxy module, sending indication information of disabling the Bluetooth hardware to a first device so that said first device disables said Bluetooth hardware according to the indication information of disabling said Bluetooth hardware; and

by said Bluetooth proxy module, sending connection configuration information to a second device so that said second device connects a Bluetooth peripheral via said Bluetooth hardware by using said connection configuration information after enabling said Bluetooth hardware, wherein said connection configuration information is a parameter used when said first device is connected to said Bluetooth peripheral via said Bluetooth hardware.

In a third aspect, an embodiment of the present disclosure provides a TV set including a Bluetooth proxy module and a Bluetooth processing module; both said Bluetooth processing module and a second device are connected to Bluetooth hardware, and said Bluetooth processing module and said second device do not enable said Bluetooth hardware at the same time; both said Bluetooth processing module and said second device are connected to said Bluetooth proxy module;

said Bluetooth proxy module is configured to send indication information of disabling said Bluetooth hardware to said Bluetooth processing module so that said Bluetooth processing module disables said Bluetooth hardware according to the indication information of disabling said Bluetooth hardware after receiving the indication information of disabling said Bluetooth hardware; and

said Bluetooth proxy module is further configured to send connection configuration information to said second device so that said second device connects said Bluetooth peripheral via said Bluetooth hardware by using said connection configuration information after receiving said connection configuration information and enabling said Bluetooth hardware, wherein said connection configuration information is a parameter used when said TV set is connected to a Bluetooth peripheral via said Bluetooth hardware.

### BRIEF DESCRIPTION OF THE DRAWINGS

In order to describe the technical solutions of the embodiments of the present disclosure more clearly, the accompanying drawings to be used in the embodiments will be introduced briefly. Obviously, the accompanying drawings to be described below are just illustrate some embodiments of the present disclosure, and a person of ordinary skill in the art can obtain other drawings according to those drawings without paying any creative effort.

FIG. 1 is a schematic architecture diagram of a system for sharing Bluetooth hardware according to one embodiment of the present disclosure;

FIG. 2 is a schematic flowchart of a method for sharing Bluetooth hardware according to one embodiment of the present disclosure;

FIG. 3 is a schematic flowchart of another method for sharing Bluetooth hardware according to one embodiment of the present disclosure;

FIG. 4 is a schematic diagram showing a structure relation between a first device and Bluetooth hardware according to one embodiment of the present disclosure;

FIG. 5 is a schematic diagram showing another structure relation between a first device and Bluetooth hardware according to one embodiment of the present disclosure;

FIG. 6 is a schematic diagram showing a structure relation between a first device and a Bluetooth proxy module according to one embodiment of the present disclosure; and

FIG. 7 is a schematic architecture diagram of a TV set according to one embodiment of the present disclosure.

### DETAILED DESCRIPTION OF THE PREFERRED EMBODIMENTS

The technical solutions of the embodiments of the present disclosure will be described below with reference to the accompanying drawings of the embodiments of the present disclosure. Obviously, those embodiments described are just a part, rather than all of embodiments of the present disclosure. All other embodiments obtained on the basis of the embodiments of the present disclosure by a person of ordinary skill in the art without paying any creative effort shall be included in the protection scope of the present disclosure.

First, description will be given to the switchover of a connection related to Bluetooth hardware between the function extension hardware and the TV set in the prior art, by taking the function extension hardware being a set-top box as an example. For example, in a case in which a TV set has been connected to a Bluetooth peripheral by using Bluetooth hardware, a process of switching the Bluetooth hardware to the set-top box from the TV set roughly has the following steps: switching off the line connection between the TV set and the Bluetooth hardware to stop supplying power to the Bluetooth hardware, turning the Bluetooth hardware off, and removing the pairings of the TV set and the Bluetooth peripheral; switching on the line connection between the set-top box and the Bluetooth hardware to supply power to the Bluetooth hardware, turning the Bluetooth hardware on, searching for the Bluetooth peripheral and pairing the set-top box with the Bluetooth peripheral to obtain configuration parameter, and connecting set-top box with the Bluetooth peripheral via the Bluetooth hardware by using the configuration parameter.

The inventor has found in the practical applications that, during the implementation of the above sharing of Bluetooth hardware, at most one of the TV set and the set-top box may be connected to the Bluetooth hardware at the same time by a line to supply power to the Bluetooth hardware, hence, during this process, it is needed to first switch off the line connection between the TV set and the Bluetooth hardware to stop supplying power to the Bluetooth hardware, and then switch on the line connection between the set-top box and the Bluetooth hardware to supply power to the Bluetooth hardware. In this way, the overall switchover speed may be decreased.

In order to solve this problem, in one embodiment of the present disclosure, a system for sharing Bluetooth hardware is provided. It is to be noted that, in the embodiment of the present disclosure, the system and method for sharing Bluetooth hardware are described just by taking the case in which two devices, i.e., a first device and a second device, share Bluetooth hardware, as an example. The system and method for a plurality of devices to share one piece of Bluetooth hardware may refer to the embodiment of the present disclosure.

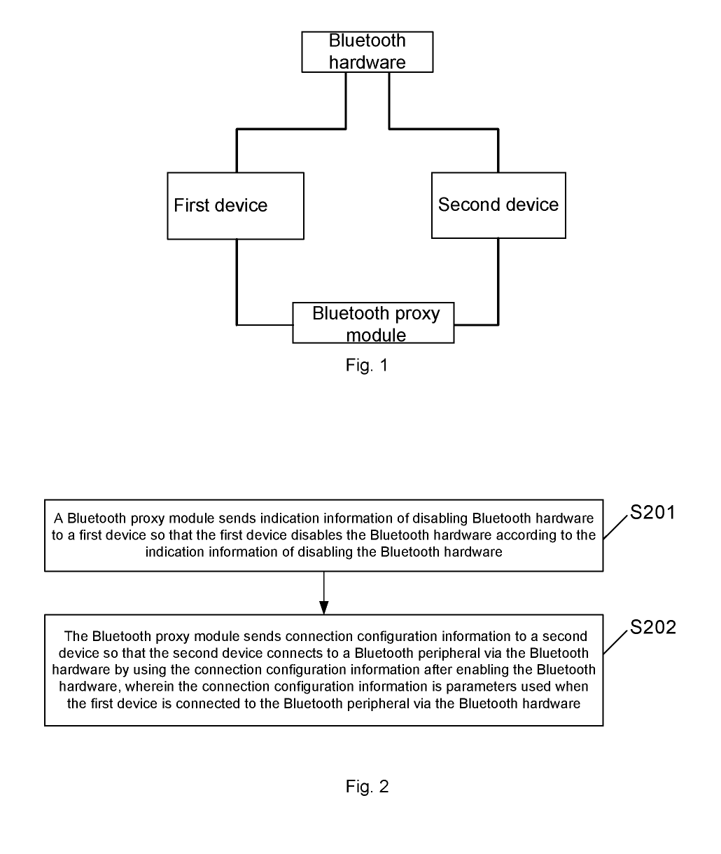

FIG. 1 is a schematic architecture diagram of a system for sharing Bluetooth hardware according to one embodiment of the present disclosure. Here, description will be given by taking switchover of the Bluetooth hardware to the second device from the first device as an example.

The system for sharing Bluetooth hardware, as shown in FIG. 1, includes the first device, the second device, Bluetooth hardware, and a Bluetooth proxy module. Those devices have the following connection relations: both the first device and the second device are connected to the Bluetooth hardware, and the first device and the second device do not enable the Bluetooth hardware at the same time; and both the first device and the second device are connected to the Bluetooth proxy module.

The Bluetooth proxy module is configured to send indication information of disabling the Bluetooth hardware to the first device, and send connection configuration information to the second device, wherein the connection configuration information is a parameter used when the first device is connected to a Bluetooth peripheral via the Bluetooth hardware.

The first device is configured to receive the indication information of disabling the Bluetooth hardware, and disable the Bluetooth hardware according to the indication information of disabling the Bluetooth hardware.

The second device is configured to receive the connect configuration information, and after enabling the Bluetooth hardware, connect to the Bluetooth peripheral via the Bluetooth hardware by using the connection configuration information.

The “first device” and “second device” may independently be devices that can perform communication via the Bluetooth technology, such as, mobile phones, computers, set-top boxes or TV sets, and will not be specifically limited herein.

The “Bluetooth hardware” may be an independent hardware device, or may be integrated with the first device or the second device. When the Bluetooth hardware is integrated with the first device or the second device, as shown in FIG. 4, the Bluetooth hardware may be integrated with the first device or the second device as an independent device; or, as shown in FIG. 5, the Bluetooth hardware is integrated in the first device or the second device as a part of the first device or the second device, that is, the first device or the second device includes the Bluetooth hardware. For example, the first device is a TV set, the second device is a set-top box, and the Bluetooth hardware is integrated in the TV set; or, the first device is a set-top box, the second device is a TV set, and the Bluetooth hardware is integrated in the set-top box; or, the first device is a computer, the second device is a TV set, and the Bluetooth hardware is integrated in the computer.

It is to be noted that, when the Bluetooth hardware is integrated in the first device or the second device, that is, when the first device or the second device includes the Bluetooth hardware, the communication between the Bluetooth hardware and the first device or the second device is the communication between the Bluetooth hardware and a functional module other than the Bluetooth hardware in the first device or the second device. For ease of description, when the first device or the second device includes the Bluetooth hardware, a functional module other than the Bluetooth hardware in the first device or the second device is also called first device or second device, respectively. However, actually, there is difference between such a functional module and the first device or the second device.

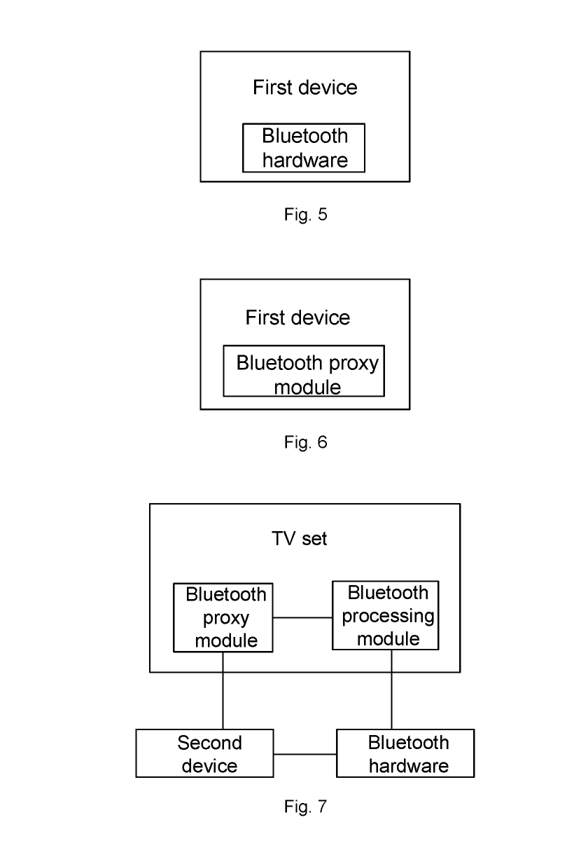

The “Bluetooth proxy module” is an independent functional module, the existence of which relies on one physical entity, wherein the physical entity may be the first device or the second device. That is, as shown in FIG. 6, the Bluetooth proxy module is integrated in the first device or the second device. In other words, the Bluetooth proxy module may belong to the first device or the second device. In addition, this physical entity also may be another device other than the first device and the second device. For example, the Bluetooth proxy module may be one chip.

It is to be noted that, when the Bluetooth proxy module belongs to the first device or the second device, that is, when the first device or the second device includes the Bluetooth hardware, the communication between the Bluetooth proxy module and the first device or the second device is the communication between the Bluetooth hardware and a functional module other than the Bluetooth proxy module in the first device or the second device. For ease of description, when the first device or the second device includes the Bluetooth hardware, a functional module other than the Bluetooth proxy module in the first device or the second device is also called first device or second device, respectively. However, actually, there is difference between such a functional module and the first device or the second device.

The “Bluetooth peripheral” also may be a device that can perform communication via the Bluetooth technology, such as, a mobile phone, a computer, a set-top box or a TV set.

Both the first device and the second device are connected to the Bluetooth hardware. The specific implementation may be as follows: both the first device and the second device are directly connected to the Bluetooth hardware; or, the first device is directly connected to the Bluetooth hardware and the second device is connected to the first device, so that both the first device and the second device are connected to the Bluetooth hardware; or, the second device is directly connected to the Bluetooth hardware and the first device is connected to the second device, so that both the first device and the second device are connected to the Bluetooth hardware; or, both the first device and the second device are indirectly connected to the Bluetooth hardware. In addition, the specific implementation also may be as follows: the Bluetooth hardware belongs to the first device and the first device is connected to the second device; or, the Bluetooth hardware belongs to the second device and the first device is connected to the second device. The first device and the second device may be connected by UART (Universal Asynchronous Receiver and Transmitter), or by SPI (Serial Peripheral Interface), or even by a USB interface or a HiLink interface, and the way of connection will not be specifically limited herein.

In the embodiment of the present disclosure, both the connection between the first device and the Bluetooth hardware and the connection between the second device and the Bluetooth hardware are hardware connections, i.e., physical connections, for example, line connections. Further, even if hardware (or physical) connections are established between the first device and the Bluetooth hardware and between the second device and the Bluetooth hardware, the first device and the second device will not supply power to this Bluetooth hardware at a same moment. The second device supplies power to the Bluetooth hardware only when the first device does not supply power to this Bluetooth hardware. Furthermore, the first device supplies power to the Bluetooth hardware only when the second device does not supply power to this Bluetooth hardware. For example, the second device supplies power to the Bluetooth hardware only after receiving connection configuration information. Furthermore, even if hardware (or physical) connections are established between the first device and the Bluetooth hardware and between the second device and the Bluetooth hardware, the first device and the second device cannot use this Bluetooth hardware directly. The first device or the second device can use the Bluetooth hardware only after turning this Bluetooth hardware on. In addition, regardless of whether the first device and the second device enable or disable the Bluetooth hardware, both the first device and the second device are always kept in physical connection to the Bluetooth hardware.

The first device and the second device will not enable the Bluetooth hardware at the same time. Of course, both the first device and the second device may not enable (i.e., disable) the Bluetooth hardware. The first device and the second device may enable or disable the Bluetooth hardware under the control of the Bluetooth proxy module. For example, the Bluetooth proxy module is further configured to send indication information of enabling the Bluetooth hardware to the second device. In this case, the second device is further configured to receive the indication information of enabling the Bluetooth hardware, and enable the Bluetooth hardware according to the indication information of enabling the Bluetooth hardware. In addition, the first device or the second device also may enable the Bluetooth hardware when detecting that no any device enables the Bluetooth hardware.

In order to ensure that the first device and the second device will not enable the Bluetooth hardware at the same time, during the specific implementation, the first device is further configured to reply a response message of disabling the Bluetooth hardware to the Bluetooth proxy module after disabling the Bluetooth hardware; the Bluetooth proxy module, during the execution of sending of the indication information of enabling the Bluetooth hardware to the second device, is specifically configured to send the indication information of enabling the Bluetooth hardware to the second device after receiving the response message of disabling the Bluetooth hardware replied by the first device.

It is to be noted that, in this embodiment, functions of various devices in this system are described based on the connection of the first device to the Bluetooth peripheral via the Bluetooth hardware. The first device may be connected to the Bluetooth peripheral by searching and pairing, or in a way similar to “the way of connecting the second device to the Bluetooth peripheral”. Specifically, the first device may, after enabling the Bluetooth hardware, search for surrounding devices first; and then, pair with one of the searched devices (i.e., “Bluetooth peripheral”), generate connection configuration information, and record this connection configuration information in a Bluetooth configuration file (for example, bt_config.xml). In addition, the first device may, after enabling the Bluetooth hardware, be connected to the Bluetooth peripheral by directly using this connection configuration information if determining that its Bluetooth configuration file contains this connection configuration information.

The Bluetooth proxy module may send the indication information of disabling the Bluetooth hardware to the first device under the trigger of a user. After the first device disables the Bluetooth hardware, the Bluetooth hardware is idle, and then the second device may enable the Bluetooth hardware. Meanwhile, the first device disables a software module, related to the Bluetooth hardware, in the operating system of the first device. Optionally, the first device may further uninstall the driver of this Bluetooth hardware, so that the first device disables the function of being connected to the Bluetooth peripheral via this Bluetooth hardware.

Before the second device is connected to the Bluetooth peripheral, the second device needs to install the driver of the Bluetooth hardware, and turn on a software module, related to the Bluetooth hardware, in the operating system of the second device, so that the second device has the function of being connected to the Bluetooth peripheral via this Bluetooth hardware.

The “connection configuration information” may include the following information: tag, name, type, class, MAC (Media Access Control) address or the like of the Bluetooth peripheral. In one embodiment of the present disclosure, since the Bluetooth proxy module is connected to the first device, the Bluetooth proxy module may acquire the connection configuration information recorded in the Bluetooth configuration file of the first device. Specifically, it may obtain the connection configuration information by parsing the Bluetooth configuration file of the first device.

In the system for sharing Bluetooth hardware provided in this embodiment of the present disclosure, the Bluetooth hardware is connected to both the first device and the second device, and the Bluetooth proxy module controls the first device to disable the Bluetooth hardware and sends connection configuration information to the second device so that the second device connects the Bluetooth peripheral by using this connection configuration information after enabling the Bluetooth hardware, wherein this connection configuration information is a parameter used when the first device is connected to this Bluetooth peripheral. Since the Bluetooth hardware is connected to both the first device and the second device, during the switchover of the Bluetooth hardware to the second device from the first device, even if the first device disables the Bluetooth hardware, the second device may supply power to the Bluetooth hardware. In this way, the following problem in the prior art may be avoided: since at most one device is connected to the Bluetooth device, during the sharing of the Bluetooth hardware, it is necessary to switch off the line connection between the TV set and the Bluetooth hardware first and then switch on the line connection between the set-top box and the Bluetooth hardware, and as a result, the overall switchover speed is slow. In addition, during this process of the embodiment, the second device may be connected to the Bluetooth peripheral without needing to perform searching and pairing. Compared with the prior art, the overall switchover speed may be further improved.

It is to be noted that, when multiple devices share the Bluetooth hardware, the Bluetooth hardware and the Bluetooth proxy module are connected to the multiple devices, respectively. However, according to the properties of the Bluetooth communication technology, at a same moment, the Bluetooth hardware may be utilized by one device at most. That is, at a same moment, at most one device may be connected with a same Bluetooth peripheral via the Bluetooth hardware.

In one optional implementation, the first device is specifically configured to close the Bluetooth function according to the indication information of disabling the Bluetooth hardware in order to disable the Bluetooth hardware. Further optionally, the first device is specifically configured to close the Bluetooth function from an APP layer according to the indication information of disabling the Bluetooth hardware in order to disable the Bluetooth hardware. In this way, it can be ensured that the first device disables the Bluetooth hardware.

In one optional implementation, the Bluetooth proxy module is specifically configured to send connection configuration information to the second device after detecting that the second device is connected to the first device. In this way, after enabling the Bluetooth hardware, the second device may be connected to the Bluetooth peripheral by directly using this connection configuration information.

Further optionally, the Bluetooth proxy module is specifically configured to send connection configuration information to the second device, if determining that the second device does not contain the connection configuration information, after detecting that the second device is connected to the first device. This further optional implementation may be interpreted as follows: the Bluetooth proxy module synchronizes the latest connection configuration information of the first device to the second device.

For example, during the running of the whole system, the Bluetooth proxy module is always running. Since the Bluetooth proxy module is connected to multiple devices (including the first device, the second device or the like) sharing Bluetooth hardware, theoretically, the Bluetooth proxy module may detect whether one or more of the multiple devices sharing Bluetooth hardware are connected with other devices. Actually, the Bluetooth proxy module may perform detection in the following optional implementations: if the Bluetooth proxy module belongs to one (hereinafter referred to as the master device) of the multiple devices (including the first device, the second device or the like) sharing Bluetooth hardware, this master device may detect at any time whether there are other devices connected to this master device; or, if the Bluetooth proxy module is a device independent of the multiple devices sharing Bluetooth hardware, the Bluetooth proxy module may detect at any time whether there are other devices connected to the devices sharing Bluetooth hardware being currently connected to the Bluetooth peripheral.

FIG. 2 is a schematic flowchart of a method for sharing Bluetooth hardware according to one embodiment of the present disclosure. The method of this embodiment may be applied to the system for sharing Bluetooth hardware as described above. The explanations of related contents of this embodiment may refer to the above description. The method as shown in FIG. 2 may include the following steps S201-S202.

S201: A Bluetooth proxy module sends indication information of disabling Bluetooth hardware to a first device so that the first device disables the Bluetooth hardware according to the indication information of disabling the Bluetooth hardware.

S202: The Bluetooth proxy module sends connection configuration information to a second device so that the second device connects to a Bluetooth peripheral via the Bluetooth hardware by using the connection configuration information after enabling the Bluetooth hardware, wherein the connection configuration information is a parameter used when the first device is connected to the Bluetooth peripheral via the Bluetooth hardware.

Optionally, this method may further include: by the Bluetooth proxy module, sending indication information of enabling the Bluetooth hardware to the second device so that the second device enables the Bluetooth hardware according to the indication information of enabling the Bluetooth hardware.

Optionally, S202 may include: sending connection configuration information to the second device after detecting that the second device is connected to the first device. In one embodiment of the present disclosure, the second device and the first device are not directly connected, but connected by a Bluetooth proxy module. In another embodiment of the present disclosure, the second device and the first device are directly connected. Preferably, S202 may specifically include: sending connection configuration information to the second device, if determining that the second device does not contain the connection configuration information, after detecting that the second device is connected to the first device.

Optionally, the Bluetooth proxy module belongs to the first device or the second device.

In the methods for sharing Bluetooth hardware provided in the above embodiments of the present disclosure, the Bluetooth hardware is connected to both the first device and the second device, and the Bluetooth proxy module controls the first device to disable the Bluetooth hardware and sends connection configuration information to the second device so that the second device connects the Bluetooth peripheral by using this connection configuration information after enabling the Bluetooth hardware, wherein this connection configuration information is a parameter used when the first device is connected to this Bluetooth peripheral. Since the Bluetooth hardware is connected to both the first device and the second device, during the switchover of the Bluetooth hardware to the second device from the first device, even if the first device disables the Bluetooth hardware, the second device may supply power to the Bluetooth hardware. In this way, the following problem in the prior art may be avoided: since only one device at most is connected to the Bluetooth device, during the sharing of the Bluetooth hardware, it is necessary to switch off the line connection between the TV set and the Bluetooth hardware first and then switch on the line connection between the set-top box and the Bluetooth hardware, and as a result, the overall switchover speed is slow. In addition, during this process of the above embodiments, the second device may be connected to the Bluetooth peripheral without needing to perform searching and pairing. Compared with the prior art, the overall switchover speed may be further improved.

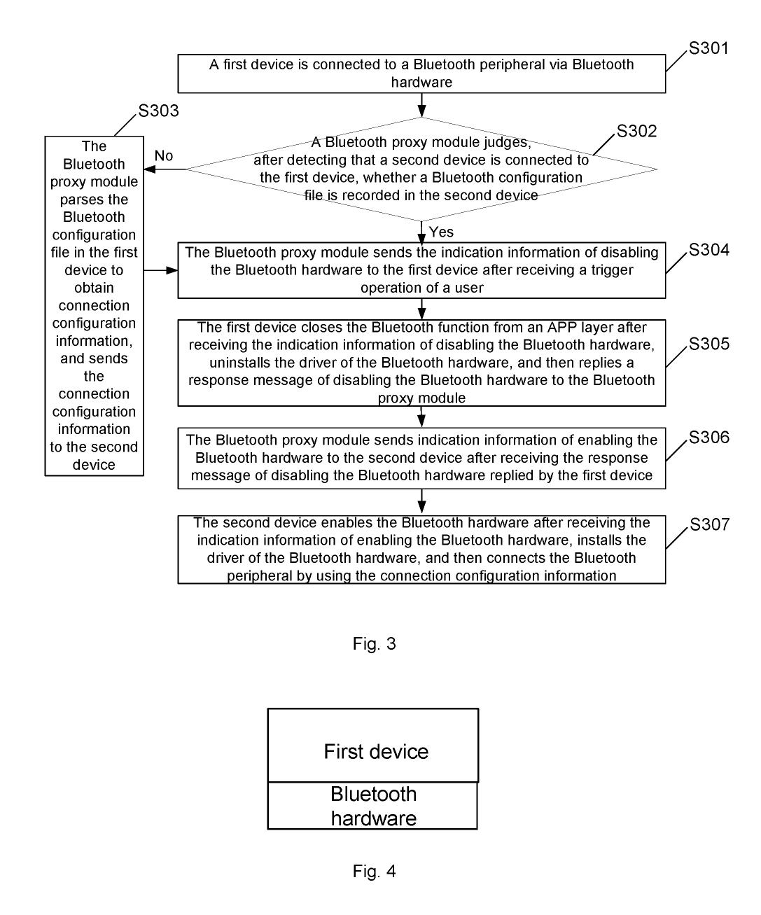

FIG. 3 is a schematic flowchart of another method for sharing Bluetooth hardware according to one embodiment of the present disclosure. The method of this embodiment may be applied to the system for sharing Bluetooth hardware as described above. The explanations of related contents of this embodiment may refer to the above description. The method as shown in FIG. 3 may include the following steps S301-S307:

S301: A first device is connected to a Bluetooth peripheral via Bluetooth hardware.

S302: A Bluetooth proxy module judges, after detecting that a second device is connected to the first device, whether a Bluetooth configuration file is recorded in the second device, wherein the Bluetooth configuration file is a parameter used when the first device is connected to the Bluetooth peripheral.

If a Bluetooth configuration file is recorded in the second device, S304 is directly executed; and if no Bluetooth configuration file is recorded in the second device, S303 is executed, followed by S304.

S303: The Bluetooth proxy module parses the Bluetooth configuration file in the first device to obtain connection configuration information, and sends the connection configuration information to the second device.

S304: The Bluetooth proxy module sends the indication information of disabling the Bluetooth hardware to the first device after receiving a trigger operation of a user.

S305: The first device closes the Bluetooth function from an APP layer after receiving the indication information of disabling the Bluetooth hardware, uninstalls the driver of the Bluetooth hardware, and then replies a response message of disabling the Bluetooth hardware to the Bluetooth proxy module.

S306: The Bluetooth proxy module sends indication information of enabling the Bluetooth hardware to the second device after receiving the response message of disabling the Bluetooth hardware replied by the first device.

S307: The second device enables the Bluetooth hardware after receiving the indication information of enabling the Bluetooth hardware, installs the driver of the Bluetooth hardware, and then connects to the Bluetooth peripheral by using the connection configuration information.

The method for sharing Bluetooth hardware will be simply described by taking the first device being a TV set and the second device being a set-top box as an example, in order to describe how the connection between the TV set and the Bluetooth peripheral is switched to the connection between the set-top box and the Bluetooth peripheral. This method for sharing Bluetooth hardware may include the following steps.

S401: A TV set is connected to a Bluetooth peripheral via Bluetooth hardware, wherein the Bluetooth hardware is integrated in the TV set. That is, the TV set includes the Bluetooth hardware.

S402: A Bluetooth proxy module judges, after detecting that a set-top box is connected to the TV set, whether a Bluetooth configuration file is recorded in the set-top box, wherein the Bluetooth proxy module is integrated in the set-top box, that is, the set-top box includes the Bluetooth proxy module; and the Bluetooth configuration file is a parameter used when the TV set is connected to the Bluetooth peripheral.

If a Bluetooth configuration file is recorded in the set-top box, S404 is directly executed; and if no Bluetooth configuration file is recorded in the set-top box, S403 is executed, followed by S404.

S403: The Bluetooth proxy module parses the Bluetooth configuration file (i.e., the parameter used when the TV set is connected to the Bluetooth peripheral) in the TV set to obtain connection configuration information, and sends the connection configuration information to the set-top box.

S404: The Bluetooth proxy module sends the indication information of disabling the Bluetooth hardware to the TV set after receiving a trigger operation of a user indicating to connect the set-top box to the Bluetooth peripheral.

After executing the above S404, the following steps are executed.

S405: The TV set closes the Bluetooth function from an APP layer after receiving the indication information of disabling the Bluetooth hardware, uninstalls the driver of the Bluetooth hardware, and then replies a response message of disabling the Bluetooth hardware to the Bluetooth proxy module.

S406: The Bluetooth proxy module sends indication information of enabling the Bluetooth hardware to the set-top box after receiving the response message of disabling the Bluetooth hardware replied by the TV set.

S407: The set-top box enables the Bluetooth hardware after receiving the indication information of enabling the Bluetooth hardware, installs the driver of the Bluetooth hardware, and then connects to the Bluetooth peripheral by using the connection configuration information.

FIG. 7 is a schematic architecture diagram of a TV set according to one embodiment of the present disclosure. The TV set is the first device as described in any one of the above embodiments, wherein the Bluetooth proxy module is integrated in the TV set, that is, the TV set includes the Bluetooth proxy module. In this embodiment, a functional module other than the Bluetooth proxy module in the TV set is called Bluetooth processing module. That is, the TV set includes a Bluetooth proxy module and a Bluetooth processing module.

The second device, the Bluetooth proxy module, the Bluetooth processing module of the TV set, and the Bluetooth hardware have the following connection relations: both the Bluetooth processing module and the second device are connected to the Bluetooth hardware, and the Bluetooth processing module and the second device do not enable the Bluetooth hardware at the same time; and both the Bluetooth processing module and the second device are connected to the Bluetooth proxy module of the TV set.

Here, description will be given by taking switchover of the Bluetooth hardware to the second device from the TV set as an example. The Bluetooth proxy module is configured to send indication information of disabling the Bluetooth hardware to the Bluetooth processing module so that the Bluetooth processing module disables the Bluetooth hardware according to the indication information of disabling the Bluetooth hardware after receiving the indication information of disabling the Bluetooth hardware.

The Bluetooth proxy module is further configured to send connection configuration information to the second device so that the second device connects to a Bluetooth peripheral via the Bluetooth hardware by using the connection configuration information after receiving the connection configuration information and enabling the Bluetooth hardware, wherein the connection configuration information is a parameter used when the TV set is connected to a Bluetooth peripheral via the Bluetooth hardware.

The arrangements and functions of the second device, the Bluetooth proxy module and the Bluetooth hardware may refer to those of the second device, the Bluetooth proxy module and the Bluetooth hardware as described in any one of the above embodiments, and will not be repeated herein.

In the TV set provided in this embodiment of the present disclosure, both the second device and the Bluetooth processing module in the TV set are connected to the Bluetooth hardware, and the Bluetooth proxy module controls the Bluetooth processing module to disable the Bluetooth hardware and sends connection configuration information to the second device so that the second device connects the Bluetooth peripheral by using this connection configuration information after enabling the Bluetooth hardware, wherein this connection configuration information is a parameter used when the TV set is connected to this Bluetooth peripheral. Since the Bluetooth hardware is connected to both the TV set and the second device, during the switchover of the Bluetooth hardware to the second device from the TV set, even if the TV set disables the Bluetooth hardware, the second device may supply power to the Bluetooth hardware. In this way, the following problem in the prior art may be avoided: since only one device at most is connected to the Bluetooth device, during the sharing of the Bluetooth hardware, it is necessary to switch off the line connection between the TV set and the Bluetooth hardware first and then switch on the line connection between the set-top box and the Bluetooth hardware, and as a result, the overall switchover speed is slow. In addition, during this process of this embodiment, the second device may be connected to the Bluetooth peripheral without needing to perform searching and pairing. Compared with the prior art, the overall switchover speed may be further improved.

In one optional implementation, the Bluetooth processing module of the TV set is specifically configured to close the Bluetooth function according to the indication information of disabling the Bluetooth hardware in order to disable the Bluetooth hardware. Further optionally, the Bluetooth processing module of the TV set is specifically configured to close the Bluetooth function from an APP layer according to the indication information of disabling the Bluetooth hardware in order to disable the Bluetooth hardware. In this way, it can be ensured that the TV set disables the Bluetooth hardware.

In one optional implementation, the Bluetooth proxy module is specifically configured to send connection configuration information to the second device after detecting that the second device is connected to the Bluetooth processing module of the TV set. In this way, when the second device enables the Bluetooth hardware, it may be connected to the Bluetooth peripheral by directly using this connection configuration information.

Further optionally, the Bluetooth proxy module of the TV set is specifically configured to send connection configuration information to the second device, if determining that the second device does not contain the connection configuration information, after detecting that the second device is connected to the Bluetooth processing module of the TV set. This further optional implementation may be interpreted as follows: the Bluetooth proxy module synchronizes the latest connection configuration information of the TV set to the second device.

Optionally, the Bluetooth device belongs to the first device or the second device.

Finally, it is to be noted that the foregoing embodiments are used merely for describing the technical solutions of the present disclosure, but not for limiting the present disclosure. Although the present disclosure has been described in detail with reference to the foregoing embodiments, it should be understood by a person of ordinary skill in the art that the technical solutions of the foregoing embodiments may be modified or that some of the technical features may be equivalently replaced, and those modifications or replacements will not make the essence of the corresponding technical solutions depart from the spirit and scope of the technical solutions of the embodiments of the present disclosure.

What is claimed is:

1. A system for sharing Bluetooth hardware, comprising a first device, a second device, Bluetooth hardware, and a Bluetooth proxy module;
both said first device and said second device are connected to said Bluetooth hardware, and said first device and said second device do not enable said Bluetooth hardware at the same time; both said first device and said second device are connected to said Bluetooth proxy module;
said Bluetooth proxy module is configured to send indication information of disabling said Bluetooth hardware to said first device, and send connection configuration information to said second device, wherein said connection configuration information is a parameter used when said first device is connected to a Bluetooth peripheral via said Bluetooth hardware;
said first device is configured to receive the indication information of disabling said Bluetooth hardware, and disable said Bluetooth hardware according to the indication information of disabling said Bluetooth hardware; and
said second device is configured to receive said connect configuration information, and after enabling said Bluetooth hardware, connect to said Bluetooth peripheral via said Bluetooth hardware by using said connection configuration information.

2. The system according to claim 1, wherein,
said Bluetooth proxy module is further configured to send indication information of enabling said Bluetooth hardware to said second device; and
said second device is further configured to receive the indication information of enabling said Bluetooth hardware, and enable said Bluetooth hardware according to the indication information of enabling said Bluetooth hardware.

3. The system according to claim 1, wherein,
said second device is further configured to enable said Bluetooth hardware when detecting that no other device enables said Bluetooth hardware.

4. The system according to claim 1, wherein,
said first device is specifically configured to close the Bluetooth function according to the indication information of disabling said Bluetooth hardware so as to disable said Bluetooth hardware.

5. The system according to claim 4, wherein,
said first device is specifically configured to close the Bluetooth function from an APP layer according to the indication information of disabling said Bluetooth hardware so as to disable said Bluetooth hardware.

6. The system according to claim 1, wherein,
said Bluetooth proxy module is specifically configured to send connection configuration information to said second device after detecting that said second device is connected to said first device.

7. The system according to claim 6, wherein,
said Bluetooth proxy module is specifically configured to send connection configuration information to said second device, under the condition of determining that said second device does not contain said connection configuration information, after detecting that said second device is connected to said first device.

8. The system according to claim 1, wherein said Bluetooth proxy module belongs to said first device or said second device.

9. A method for sharing Bluetooth hardware, comprising:
by a Bluetooth proxy module, sending indication information of disabling the Bluetooth hardware to a first device so that said first device disables said Bluetooth hardware according to the indication information of disabling said Bluetooth hardware; and
by said Bluetooth proxy module, sending connection configuration information to a second device so that said second device connects to a Bluetooth peripheral via said Bluetooth hardware by using said connection configuration information after enabling said Bluetooth hardware, wherein said connection configuration information is a parameter used when said first device is connected to said Bluetooth peripheral via said Bluetooth hardware.

10. The method according to claim 9, further comprising:
by said Bluetooth proxy module, sending indication information of enabling said Bluetooth hardware to said second device so that said second device enables said Bluetooth hardware according to the indication information of enabling said Bluetooth hardware.

11. A TV set comprising a Bluetooth proxy module and a Bluetooth processing module; both said Bluetooth processing module and a second device are connected to Bluetooth hardware, and said Bluetooth processing module and said second device do not enable said Bluetooth hardware at the same time; both said Bluetooth processing module and said second device are connected to said Bluetooth proxy module;
said Bluetooth proxy module is configured to send indication information of disabling said Bluetooth hardware to said Bluetooth processing module so that said Bluetooth processing module disables said Bluetooth hardware according to the indication information of disabling said Bluetooth hardware after receiving the indication information of disabling said Bluetooth hardware; and
said Bluetooth proxy module is further configured to send connection configuration information to said second device so that said second device connects to a Bluetooth peripheral via said Bluetooth hardware by using said connection configuration information after receiving said connection configuration information and enabling said Bluetooth hardware, wherein said connection configuration information is a parameter used when said TV set is connected to a Bluetooth peripheral via said Bluetooth hardware.

12. The TV set according to claim 11, wherein,
said Bluetooth proxy module is further configured to send indication information of enabling said Bluetooth hardware to said second device so that said second device enables said Bluetooth hardware according to the indication information of enabling said Bluetooth hardware after receiving the indication information of enabling said Bluetooth hardware.

13. The TV set according to claim 11, wherein,
said Bluetooth processing module is specifically configured to close the Bluetooth function according to the indication information of disabling said Bluetooth hardware so as to disable said Bluetooth hardware.

14. The TV set according to claim 13, wherein,
said Bluetooth processing module is specifically configured to close the Bluetooth function from an APP layer according to the indication information of disabling said Bluetooth hardware so as to disable said Bluetooth hardware.

15. The TV set according to claim 11, wherein,
said Bluetooth proxy module is specifically configured to send connection configuration information to said second device after detecting that said second device is connected to said Bluetooth processing module.

16. The TV set according to claim 15, wherein,
said Bluetooth proxy module is specifically configured to send connection configuration information to said second device, under the condition of determining that said second device does not contain said connection configuration information, after detecting that said second device is connected to said Bluetooth processing module.

17. The TV set according to claim 11, wherein said Bluetooth device belongs to said TV set.
